(19) United States
(12) Patent Application Publication
(10) Pub. No.: US 2017/0126654 A1
(43) Pub. Date: May 4, 2017

(54) METHOD AND SYSTEM FOR DYNAMIC PASSWORD AUTHENTICATION BASED ON QUANTUM STATES

(71) Applicant: Alibaba Group Holding Limited, George Town (KY)

(72) Inventor: Yingfang Fu, Hangzhou (CN)

(73) Assignee: Alibaba Group Holding Limited, George Town (KY)

(21) Appl. No.: 15/332,852

(22) Filed: Oct. 24, 2016

(30) Foreign Application Priority Data
Oct. 28, 2015 (CN) 201510713589.4

(51) Int. Cl. H04L 29/06; H04L 9/08; H04L 9/32

(52) U.S. Cl. CPC H04L 63/083; H04L 9/3226; H04L 63/0435; H04L 9/0852

(57) ABSTRACT

One embodiment described herein provides a client-side process for performing dynamic-password authentication between a client and a server. This client-side process includes the steps of: generating, by the client, a service request comprising a first dynamic message; transmitting the first service request to the server; receiving a second dynamic message from the server in response to the first dynamic message for cross-validating the server; authenticating the second dynamic message to verify the validity of the server. If the validity of the server is verified, the client-side process further includes: generating a third dynamic message based on the second dynamic message; and transmitting the third dynamic message to the server for a final approval of the service request.

### RELATED APPLICATION

Under 35 U.S.C. 119, this application claims the benefit and right of priority of Chinese Patent Application No. 201510713589.4, filed on 28 Oct. 2015.

### BACKGROUND

Field

This disclosure is generally related to encryption technologies. More specifically, this disclosure is related to techniques, devices, and systems for performing dynamic password token authentication based on using quantum states.

Related Art

With the exponential growth in data communication and telecommunication over the computer networks including the Internet, the technologies for data security to protect private information passed on the computer networks from eavesdropping and other attacks have also been constantly improving and evolving. Traditionally, various password-based authentication protocols provide two entities (e.g., a client and a server) in secure communication to authenticate their identities to each other. These authentication protocols can include static-password authentication protocols, synchronous dynamic-password authentication protocols, and asynchronous dynamic-password authentication protocols, among others.

Static-password authentication mechanism is generally vulnerable to many forms of attacks, such as eavesdropping attacks, password guessing attacks, replay attacks, and password leaks, among others. Hence, although static-password authentication remains a popular authentication tool, it is the least secure authentication mechanism. In contrast, both synchronous and asynchronous dynamic-password authentication mechanisms provide significantly more securities against aforementioned attacks, yet remain easy to use and allow for seamless interoperations among a variety of business systems. Hence, dynamic-password authentication technology has quickly become the mainstream identity authentication technology, and has been widely used in e-commerce, online gaming, finance and many other business fields that require secure communication.

As mentioned above, the most commonly used dynamic-password authentication technology is mainly based on synchronous-password authentication protocols and asynchronous-password authentication protocols, which typically involve some form of challenge-response mechanism. Unfortunately, the existing synchronous and asynchronous dynamic-password authentication protocols still suffer from deficiencies such as the lack of mutual authentication, vulnerabilities to the smaller number (or small n) attacks and the man-in-the-middle attacks, and vulnerability to the leaks of sensitive/confidential data from both the client side and the server side.

### SUMMARY

One embodiment described herein provides a client-side process for performing dynamic-password authentication between a client and a server. This client-side process includes the steps of: generating, by the client, a service request comprising a first dynamic message; transmitting the first service request to the server; receiving a second dynamic message from the server in response to the first dynamic message for cross-validating the server; authenticating the second dynamic message to verify the validity of the server. If the validity of the server is verified, the client-side process further includes: generating a third dynamic message based on the second dynamic message; and transmitting the third dynamic message to the server for a final approval of the service request.

In a variation on this embodiment, the first dynamic message also includes identification information of the client.

In a variation on this embodiment, the first dynamic message is encrypted with a symmetric key shared between the client and the server.

In a variation on this embodiment, the process generates the first service request by: randomly selecting one or more quantum state bases from a pre-installed quantum state basis library, with each quantum state basis in the quantum state basis library including a set of orthogonal quantum states, and is associated with a unique quantum state identifier (QID); assigning a random length value to each selected quantum state basis; and forming the first dynamic message using QIDs and assigned length values of the selected quantum state bases.

In a further variation, the process verifies the validity of the server by: processing the second dynamic message to obtain a set of dynamic values; and comparing the set of dynamic values with a set of expected values based on the QIDs and length values included in the first dynamic message; and if the set of dynamic values match the set of expected values, determining that the validity of the server is verified; otherwise, determining that the validity of the server cannot be verified.

In a further variation, the second dynamic message includes a quantum bit string and an encrypted message. The quantum bit string is generated by the server based on the QIDs and assigned length values in the first dynamic message, and processing the second dynamic message includes: selecting a set of measurement bases based on the QIDs, and measuring the received quantum bit string using the selected measurement bases to obtain a set of measurement results.

In a further variation, the set of expected values is indicated by the encrypted message, and comparing the set of dynamic values with the set of expected values includes comparing the set of measurement results with the set of expected values to determine if the server is valid.

In a further variation, the third dynamic message includes the set of measurement results and a set of quantum state identifiers that identify quantum states used for obtaining the set of measurement results.

In another aspect of this disclosure, a server-side process for performing dynamic-password authentication between a client and a server is disclosed. This service-side process includes the steps of: receiving, by the server, a service request comprising a first dynamic message and identity information from the client; and verifying the validity of the client based on the identity information. If the validity of the client is verified, the server-side process continues by: processing the first dynamic message to obtain a set of dynamic information; generating a second dynamic message based on the set of dynamic information; and transmitting the second dynamic message to the client to allow the client to cross-validate the server.

In a variation on this embodiment, the first dynamic message includes a set of quantum state basis identifiers (QIDs) and a set of length values, with each length value corresponding to a QID, and each QID corresponds to a quantum state basis in a quantum state basis library pre-installed on both the client and the server. Each quantum state basis includes a set of orthogonal quantum states.

In a variation on this embodiment, the process obtains the set of dynamic information by obtaining the set of QIDs and length values.

In a variation on this embodiment, the process generates the second dynamic message based on the set of dynamic information by: generating a random binary bit string, with a length of the random binary bit string being the sum of the length values; generating a quantum bit string from the random binary bit string based on the obtained QIDs and length values; and generating a set of decimal numbers from the random binary bit string based on the length values.

In a further variation, the process encrypts the set of decimal numbers using a symmetric key shared by the client and the server.

In a variation on this embodiment, the process further comprises receiving a third dynamic message in response to the second dynamic message from the client; and analyzing the third dynamic message to further determine the validity of the client. If the client is valid, the process authorizes the service request; otherwise, the process denies the service request.

In a further variation, the third dynamic message includes a measurement result of a quantum bit string included in the second dynamic message, wherein the measurement result is obtained by the client based on information included in the first dynamic message.

### BRIEF DESCRIPTION OF THE FIGURES

FIG. 1 illustrates a flow diagram of an exemplary dynamic-password authentication process in accordance with one embodiment described herein.

FIG. 2A presents a flowchart illustrating a client-side process of the disclosed dynamic-password authentication process in accordance with one embodiment described herein.

FIG. 2B presents a diagram illustrating a client device in accordance with one embodiment described herein.

FIG. 3 presents a flowchart illustrating a process for verifying the identity of the server sending the dynamic information, in accordance with one embodiment described herein.

FIG. 4A presents a flowchart illustrating a server-side process of the disclosed dynamic-password authentication process in accordance with one embodiment described herein.

FIG. 4B presents a diagram illustrating a server device, in accordance with one embodiment described herein.

FIG. 5 presents a flowchart illustrating a process for generating dynamic information for server validation in accordance with one embodiment described herein.

FIG. 6 illustrates an example client-server network environment which provides for implementing the disclosed dynamic-password authentication process in accordance with some embodiments described herein.

FIG. 7 conceptually illustrates an electronic system with which some implementations of the subject technology are implemented.

Table 1 illustrates two exemplary mechanical quantity measurement schemes based on using two different sets of quantum states in accordance with one embodiment described herein.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

In quantum communication, information is transmitted based on quantum states, and the data security can be guaranteed by the laws of quantum mechanics, such as the uncertainty principle, the principle of quantum state measurement, and no-cloning theorem. It has been shown that quantum cryptography can achieve unconditional data transmission security and detectability against eavesdroppers.

Various embodiments disclosed herein provide a dynamic-password authentication technique based on quantum states. In one aspect, the disclosed dynamic-password authentication technique includes dynamically exchanging secure information between the client and the server by way of transmitting the information in form of quantum states. Due to the dynamic nature of the quantum states, the data exchange based on these quantum states can avoid traditional dynamic-password authentication deficiencies such as the lack of mutual authentication, vulnerabilities to decimal attacks and man-in-the-middle attacks, and vulnerability to the leaks of sensitive/confidential data from both the client side and the server side.

### BACKGROUND

Basic Quantum Theory

According to quantum physics, some physical quantities of the microscopic world cannot continuously change but take on certain discrete values, and the difference between two adjacent discrete values is referred to as a “quantum,” e.g., a photon is a single quantum of light. It can be said is a quantum is a microscopic particle or photon with special properties.

Quantum States

Classical digital information can be represented as bits, wherein each bit can have two states: e.g., “0s” and “1s,” or “high” and “low” voltages. In contrast, quantum information is typically represented as qubits, wherein each qubit can have two basic states: |0> or [symbol] and |1> or [symbol] . In this case, the two quantum states |0> and |1> form a quantum state basis, which can be expressed as {|0>, |1>}.

Moreover, a quantum quantity can also take on a mixed state obtained by the superposition of the two basic states with coefficients α, β, respectively. For example, if quantum basis {|0>, |1>} is used, then a mixed state can be expressed as:

|φ [symbol] =α|0 [symbol] +β|1 [symbol] .

For example, mixed quantum state basis {|+ [symbol] , |− [symbol] } can be generated by superpositioning the basic quantum states |0>/ [symbol] and |1>/ [symbol] using the following formulae:

$$\vert + 〉 = \frac{↔ + ↕}{\sqrt{2}} , \\ \vert - 〉 = \frac{↔ - ↕}{\sqrt{2}} .$$

Note that in the above two bases of quantum state representations, states |0> and |1> are orthogonal to each other while states |+> and |−> are orthogonal to each other.

Principle of Quantum Measurements

In quantum mechanics, a given mechanical quantity can be measured using above-described quantum states, which are also referred to as “measurement basis.” For example, each mechanical quantity can be expressed by a Hermitian operator (or Hermitian matrix). When measuring such a mechanical quantity, the measurement results correspond to the eigenvalues (or the “characteristic values”) of the Hermitian operator for this mechanical quantity. After the measurement, the quantum state being measured collapses to the eigenstates (or the “eigenvectors”) corresponding to the obtained eigenvalues. Table 1 illustrates two exemplary mechanical quantity measurement schemes based on using two different sets of quantum states in accordance with one embodiment described herein.

TABLE I
Mechanical quantity measurement using a set of quantum states

| | | |
|---|---|---|
| Mechanical Quantity $Z = ( \begin{matrix}1 & 0 \\ 0 & - 1\end{matrix} )$ | Eigenvalues: 1, −1 Eigenstates: \|0 [symbol] , \|1 [symbol] | Referred to as measuring using set {\|0 [symbol] , \|1 [symbol] } |
| Mechanical Quantity $Z = ( \begin{matrix}0 & 1 \\ 1 & 0\end{matrix} )$ | Eigenvalues: 1, −1 Eigenstates: \|+ [symbol] , \|− [symbol] | Referred to as measuring using set {\|+ [symbol] , \|− [symbol] } |

For example, when using quantum state basis {|0 [symbol] , |1) [symbol] } to measure quantum state |φ [symbol] =α|0 [symbol] +β|1 [symbol] , wherein |α|²+|β|²=1, we will obtain a measurement value 1 with a probability of |α|², wherein after the measurement the quantum state collapses to |0 [symbol] ; and we will obtain a measurement value −1 with a probability of |β|², wherein after the measurement the quantum state collapses to |1 [symbol] .

As another example, when using quantum state basis {|0 [symbol] , |1 [symbol] } to measure quantum state |0 [symbol] , we will obtain state |0 [symbol] with probability 1. Similarly, when using quantum state basis {|+ [symbol] , |− [symbol] } to measure quantum state |+ [symbol] , we will obtain state |+ [symbol] with probability 1.

Furthermore, when using quantum state basis {|0 [symbol] , |1 [symbol] } to measure quantum state |+ [symbol] , we will randomly obtain either state |0 [symbol] or state |1). Similarly, when using quantum state basis {|+ [symbol] , |− [symbol] } to measure state |0 [symbol] , we will randomly obtain either state |+ [symbol] or state |− [symbol] .

### Dynamic Password Authentication Schemes

Dynamic-password authentication mechanism is based on using a cryptographic protocol, which typically begins by obtaining a user's identification token and some other dynamic factors as input parameters of the cryptographic protocol. The cryptographic protocol next generates a dynamic output by transforming the inputs using a transformation program, and the output of the program is subsequently used as a user's login password. On the server side, an authentication server uses a corresponding transformation program to compute a value, which is then compared with the user's login password. If the server generated value and the user's login password match, then login request is granted. The benefit of the above authentication process is that, the password is dynamically regenerated for each new login attempt and its value is not repeated. Therefore, there is no need for a user to remember a password, because it is only used once, and a re-use attempt will result in a login rejection. Based on how the dynamic factors are selected, dynamic-password authentication protocols can be categorized into the following schemes:

Challenge-Response Scheme:

In this scheme, when a user makes a login request, the system generates a challenge message which is then sent to the user. Next, the user can generate a dynamic password based on both the received challenge message and a user's own password. The newly generated password is then entered and sent to the system, which completes a login process.

Time-Synchronous Scheme:

This technique uses the user's login time as a random factor, and combines the user's own password to generate a dynamic password. Based on a time-synchronous token (which is typically updated every 60 seconds), the system generates a new password at a predetermined time interval, such as every second. However, this technique requires that the server maintain a correct clock at very high precision.

Event-Synchronous Scheme:

Event-based synchronous token scheme is perhaps the most commonly used dynamic-password authentication technique, which works as follows. The authentication process begins when a client attempts to access a server machine. Upon receiving the login request, the server produces a challenge message and sends the challenge message to the client. Next, after receiving the challenge, the client enters a secrete passphrase/answer only known to the client, which is used by a dynamic-password generator to generate a dynamic password. This dynamic password is transmitted to the server over the network, which is subsequently verified by the server. If this dynamic password authentication is successful, the client is authorized to access the server, and the dynamic password will not be used again. Because the secrete passphrase/answer used by the client to generate the dynamic password is not transmitted over the network, nor stored anywhere on the server side and the client side, and only known to the client, therefore the secrete passphrase/answer cannot be stolen. Moreover, even if the dynamic password can be intercepted during the transmission process, the intercepted password would be of no use to the attacker because it cannot be used again.

However, the above-described dynamic-password authentication techniques have the following deficiencies.

Lack of Mutual Authentication:

As can be seen, the above-described dynamic-password authentication techniques do not provide two-way authentication, in other words, they only provide one-way authentication from the server to the client. As a result, they are lack of mechanisms to prevent a spoofing attack by a fake server against legitimate users/clients. For example, if an attacker can intercept the authentication information of the server, the attacker can pretend to be the server though a database or replay means to deceive the clients.

Vulnerable to Small n Attacks:

When a client requests authentication to the authentication server, an attacker can intercept the challenge messages (i.e., Seed and Iteration values) transmitted by the authentication server by eavesdropping on the network, and subsequently modify the Iteration value to a smaller value. The attacker then pretends to be the server to transmit the intercept Seed and the modified Iteration to the client. The client uses the attacker's Seed and Iteration to compute the one-time password and send it to the server. The attacker one again intercepts the one-time password sent by the client, and then uses a known hash function to successively compute one-time passwords corresponding to the larger Iteration values, thereby obtaining a series of passwords to be subsequently used by the client. In this manner, the attacker can impersonate legitimate users to launch decimal attacks.

Vulnerable to Man-in-the-Middle Attacks:

It has been observed that the existing dynamic-password authentication techniques are often vulnerable to the man-in-the-middle (MiM) attacks for the following reasons. An attacker located between a client and a server intercepts the authentication information, and subsequently pretends to be the client with a connection to the server on one hand, and pretends to be the server with a connection to the client on the other hand. Next, when the client transmits a one-time login password to the server, the attacker can intercept the one-time password so that the client is unable to log on. This causes a false impression to the client as if the network connection is lost or the connection is timed-out. Meanwhile, the attacker can impersonate the client using the intercepted one-time password to log on to the server.

Lack of Means of Safely Storing Sensitive Security Data:

The existing dynamic-password authentication techniques are also inadequate on both the client-side and the server-side to safely store the security information to protect such information as hardware tokens and PIN codes.

The disclosed quantum states-based dynamic-password authentication technique can effectively cure the above-described deficiencies in the existing dynamic-password authentication technique. In a particular embodiment, the disclosed dynamic-password authentication technique includes installing a quantum state basis library on the client-side, on the service-side, or on both the client-side and the server-side. To begin a service request, the client can randomly select one of the quantum state bases from the quantum state basis library, encrypt the selected quantum state basis with a public key of the server or a symmetric key shared by the client and the server, and subsequently send a service request to the server. Upon receiving the service request from the client, the server can transmit one or more dynamically-varying factors in the form of one or more mutually-agreed quantum states to the client. Next, after receiving the dynamically-varying factors, the client can perform quantum measurements on the received dynamically-varying factors, and subsequently send the measurement results in the form of ciphertext to the server. The server can then decide on whether to grant the service request to the client based on whether the measurement results match the expected results.

As can be seen, the disclosed service request authentication technique is based on using both a shared symmetric key or an identity certificate, and quantum cryptography which has the properties of non-cloning, uncertain, and collapsible when being measured. Because the disclosed quantum-state-based authentication technique does not rely on easily hijacked SMS verification code, or on sensitive data such as user's PIN, nor on time synchronization, the disclosed authentication technique can effectively prevent the above-described deficiencies in the existing dynamic-password authentication technology such as the lack of mutual authentication, vulnerabilities to decimal attacks and MiM attacks, and the inadequate security in storing sensitive data.

### Some Assumptions

In some embodiments, the disclosed authentication technique includes the following assumptions. It is assumed that, before starting data communication, each of the client and the server has its own public and private key pairs and an associated identity certificate. Alternatively, the client and the server can share a pair of symmetric quantum keys, a pair of public and private keys, and identity certificates, and the shared symmetric quantum keys can change dynamically based on service requirements. In some embodiments, the present technique takes into account the computational capacity of the client, such that when communicating with the server, the security of transmitted sensitive data can be ensured by a symmetric quantum key Key_{—AB}.

### Quantum State Basis Library

In some embodiments, the disclosed authentication technique includes installing a lightweight quantum state basis library on either of the client and the server, wherein the quantum state basis library stores a plurality of quantum state bases, each of which including orthogonal quantum states, which can be labeled for differentiation. For example, if we label the orthogonal basis {|0>, |1>} as “1,” then state |0> can be labeled as 1.1, and state |1> as 1.2; then we label the orthogonal basis {|+>, |−>} as “2,” then state |+> can be labeled as 2.1, and state |> as 2.2, and so on.

In some embodiments, the quantum states can be periodically relabeled in a synchronized manner on both the client and server sides based on a predetermined relabeling scheme. For example, if x represents the current identifier of a given quantum state, while y represents the identifier of the same quantum state for the next service request, then y can be deduced from x using some deduction rules. For example, the deduction rule can be y=2x; or y=2+x, or other rules negotiated and agreed between the client and the server before the authentication process between the client and the server. In some embodiments, in light of the disclosed dynamic-password authentication technique, the client can use the quantum states of a quantum state basis as the measurement basis for measuring the dynamic information transmitted by the server; while the server can use the same quantum state basis to encode the dynamic information.

### Quantum-State-Based Dynamic Password Authentication Process

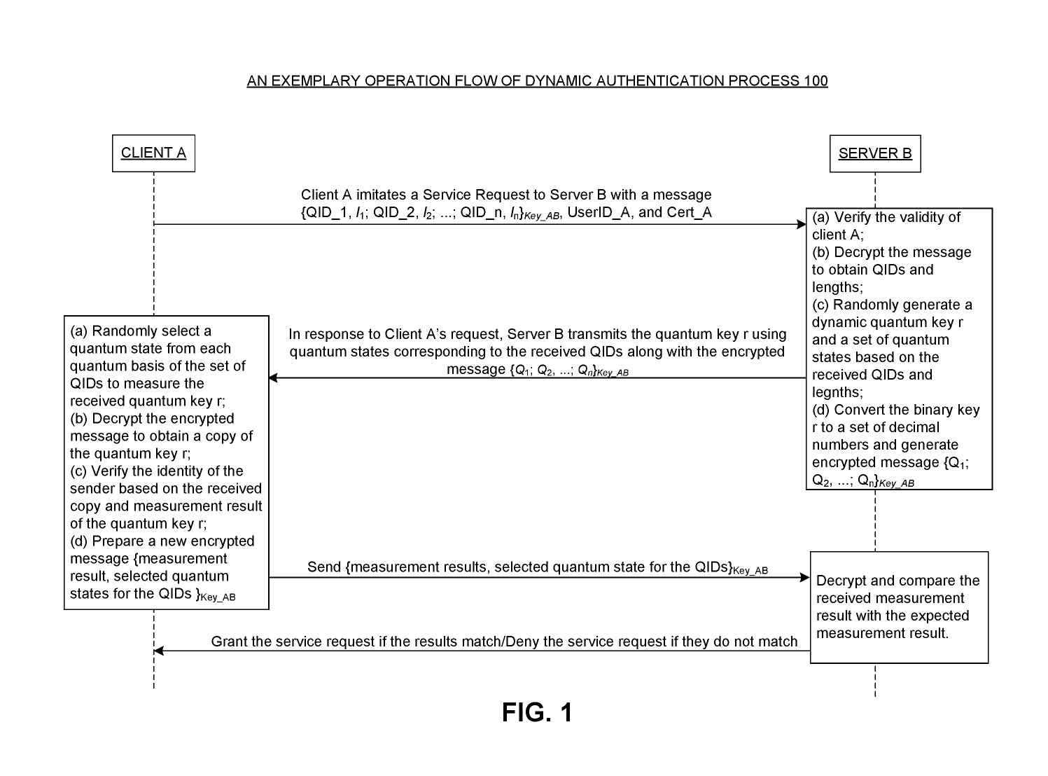

In some embodiments, the disclosed authentication technique can include some security measures used by classical https communication, such as an identity certificate and an encrypted secure communication channel, but would also include aforementioned dynamic-password authentication features based on quantum states. FIG. 1 illustrates a flow diagram of an exemplary dynamic-password authentication process 100 in accordance with one embodiment described herein. In the disclosed process 100, a server Bob is also referred to as “B,” and a client Alice is also referred to as “A.” When Alice requests for the service of Bob, FIG. 1 illustrates specific interactive steps between client A and server B of a dynamic-password authentication process based on the quantum states.

As can be seen in FIG. 1, client A can randomly select one or more quantum state bases from the quantum state basis library, wherein each of the selected quantum state bases includes a set of (e.g., two) orthogonal quantum states. Next, the quantum identifiers (QIDs) of the selected quantum state bases and lengths/of the corresponding quantum states to be transmitted along with the QIDs are encrypted with a symmetric quantum key Key_{—AB}. This produces a message {QID_1, l₁; QID_2, l₂; . . . ; Q1D_n, lₙ}_{Key}_{_}_{AB}. Note that the formed message is a dynamic message due to the randomness in the selected quantum state bases and the lengths within the message. As a result, the service request based on this dynamic message is also a dynamic service request.

The encrypted dynamic message is then transmitted to the server B along with client A's user identification (ID) UserID_A and identity certificate Cert_A as a service request. For example, if client A randomly selects two quantum state bases with QIDs 2 and 4, and specifies their corresponding lengths as 3 and 6, respectively, then the messages sent to server B can be the following: {2, 3; 4, 6}_{Key}_{_}_{AB}, userID_A, Cert_A. To enhance security, the lengths can also be encoded. For example, client A and server B can each maintain a quantum-bit-string-length database, which can map string lengths to various codes. Instead of sending the specified lengths, client A can send codes corresponding to those lengths, and upon receiving such codes, server B can perform a lookup in the quantum-bit-string-length database to determine the lengths. In alternative embodiments, client A can send only one of the userID_A and Cert_A along with the encrypted quantum state message instead of both userID_A and Cert_A.

Next, upon receiving of the service request from client A, server B can perform the following steps:

(a) Verify the validity of client A. If the identification of client A is determined to be valid, e.g., based on Cert_A and/or userID_A, the authentication process continues; otherwise, the authentication process terminates;

(b) Based on the received userID_A, search for the shared quantum symmetric key Key_{—AB};

(c) Use key Key_{—AB} to decrypt the encrypted message to obtain the data string: QID_1, l₁; QID_l₂; . . . ; QID_n, lₙ.

(d) Generate a cross-validation message for the requesting client to verify the validity of the server. More specifically, the server can randomly generate a quantum key r as the dynamic information to be sent to client A, wherein the quantum key r is a bit string having a string length of m=l₁+l₂+ . . . +lₙ. In fact, quantum key r can include n portions, with each portion comprising a randomly generated bit string, and the length of bit string is defined in the service request received from client A. In some embodiments, server B can perform an additional operation by converting the individual portions of the dynamic quantum key r to decimal numbers Q₁, Q₂, . . . , Qₙ (i.e., a first portion of the bit string having string length l₁ is converted to decimal number Q₁, a second portion of the bit string having string length l₂ is converted to decimal number Q₂, and so on, and a last portion of the bit string having string length lₙ is converted to decimal number Qₙ. In some embodiments, for each portion of the quantum key r with the corresponding length of l₁, l₂, . . . , lₙ, server B also randomly selects a state from the quantum state basis corresponding to the QID of the corresponding portion of the dynamic quantum key r, and sends the portion of the quantum key r based on the randomly selected state. In other words, for a given quantum state basis comprising two orthogonal quantum states, the process randomly selects one of the two states. For example, for a quantum state basis having QID of 1 and quantum states {|0>, |1>}, the process randomly selects state |0> or state |1>. As another example, for a quantum state basis having QID of 2 and quantum states {|+>, |−>}, the process randomly selects state |+> or state |−>. In some embodiments, the “1” bits in a bit string can be sent using the randomly selected quantum state, whereas the “0” bits can be sent using the other state. Server B subsequently transmits the randomly generated quantum key r using quantum bases specified by the service request along with the encrypted message {Q₁, Q₂, . . . Qₙ}_{Key}_{_}_{AB} to client A. For example, the first portion of quantum key r (e.g., the bit string having a length l₁) can be transmitted using quantum basis QID_1, the second portion of quantum key r (e.g., the bit string having a length l₂) can be transmitted using quantum basis QID_2, and so on.

At this point in the authentication process, server B has partially verified the identity of requesting client A based on the Cert_A and/or userID_A. Next in the authentication process, upon receiving the dynamic information (which includes the quantum bit string and the encrypted message) from server B, client A can perform the following steps:

(a) For the received quantum bit string, select a measurement basis for each portion based on the corresponding QID included in the service request previously sent to server B, and use the selected measurement basis to measure the quantum bit string (this way, client A can obtain a quantum measurement of the dynamic quantum key r);

(b) Decrypt the encryption message to obtain information Q₁, Q₂, . . . , Qₙ using decrypting key Key_{—AB}, and restore Q₁, Q₂, . . . , Qₙ back to binary bit streams (this way, client A can receive a direct copy of the dynamic quantum key r);

(c) Client A can compare the quantum measurement result of the dynamic quantum key r with the received direct copy of the dynamic quantum key r in order to verify the identity of the sender of the dynamic quantum key r to be valid server B. This is because only the valid server B knows the pre-agreed QID representations (i.e., the correct quantum state bases corresponding to the QIDs) the lengths of the individual portions of dynamic quantum key r. In some embodiments, when measuring the received quantum bit string, client A may also randomly select from a particular quantum basis a quantum state from the two orthogonal quantum states included in the particular quantum basis, and use the selected quantum state for measurement purposes. Accordingly, if a received quantum bit having a quantum state matching the selected measurement state, the measurement result of the quantum bit is “1,” and vice versa. For a valid server B, the measured length of the received dynamic quantum key r should be no greater than the length m. In some embodiments, the measured length of the dynamic quantum key r should also be no less than a threshold, considering possible ranges of light attenuation. Because server B and client A each randomly selects a quantum state to represent the “1” bits, corresponding portions of the measurement result and direct copy of quantum key r are either identical to or inverse of each other. The mismatch between the measurement result and the direct copy can indicate that either the sender is not server B, or the quantum key r has been intercepted (measured) by a third party using non-matching quantum state basis. If the identity of the sender is verified by client A to be server B, the authentication process can continue; otherwise, the authentication process terminates;

(d) Prepare a new encrypted message {quantum measurement results, the selected quantum state for each QID}_{Key}_{_}_{AB} and send the message to server B. For example, if client A selects a quantum state with an ID as 3.1 (meaning that the QID for the quantum basis is 3, and the particular state, such as |0>, can be identified as 3.1), then client A can include 3.1 in the new encrypted message to be sent to server B. In some embodiments, it is assumed that client A and the server B have a synchronized unique identifier for the same quantum state, such as that this identifier can be based on time. Note that the above described steps include the verification of server B's identity by the requesting client A. Hence, the disclosed authentication process enables the mutual authentication of the client and the server.

Upon receiving the new message from client A, server B decrypts the message to obtain the measurement result and the quantum states used by client A to obtain the measurement. Based on the quantum states, server B can deduct the expected measurement result of the quantum key r and compare the measurement result received from client A with the expected measurement result. If the received measurement result matches the expected measurement result, then the service request is authorized. Otherwise, the service request is denied and the process terminates.

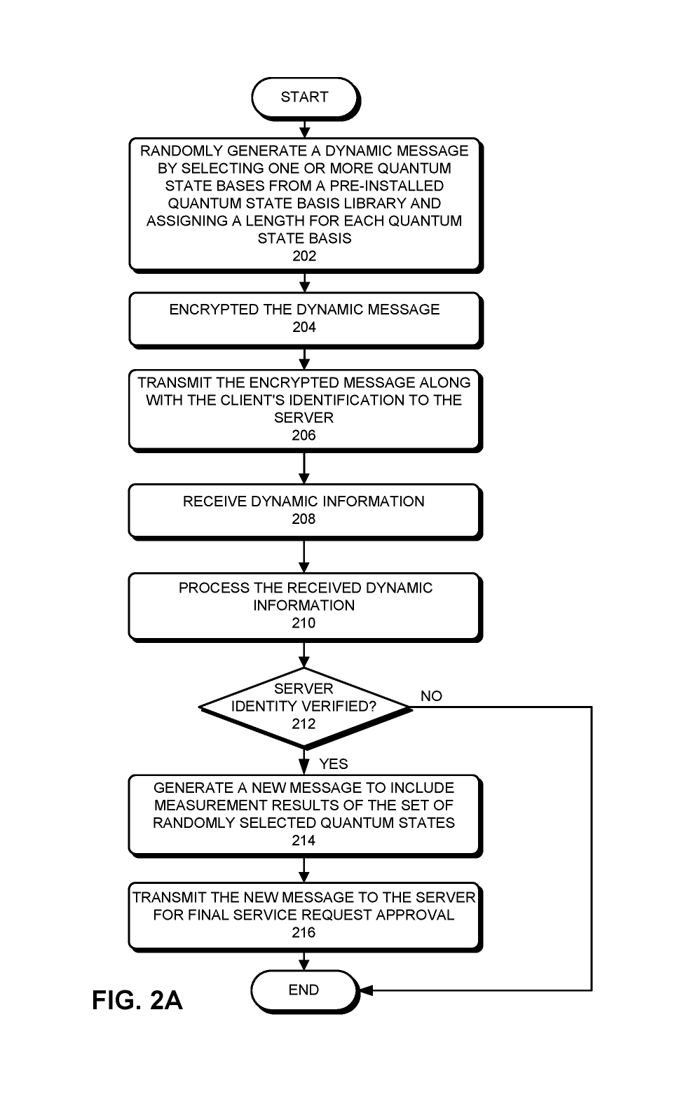

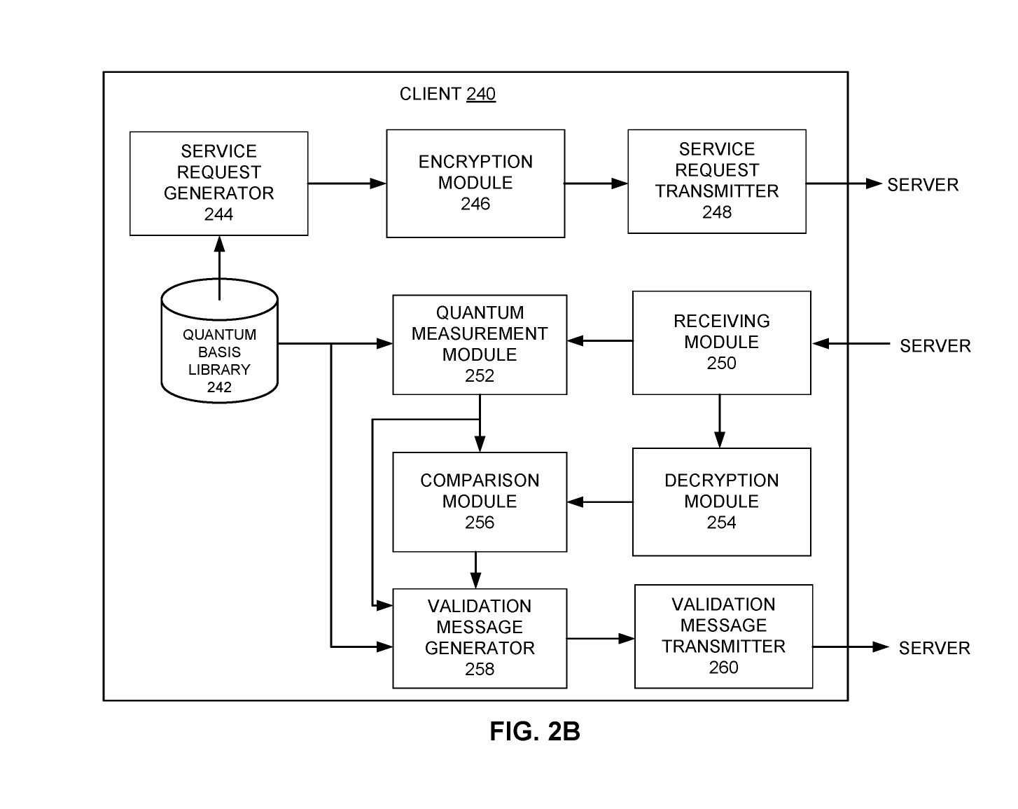

FIG. 2A presents a flowchart illustrating a client-side process of the disclosed dynamic-password authentication process in accordance with one embodiment described herein. The client process begins when the client randomly generate a dynamic message by selecting one or more quantum state bases from a pre-installed quantum state basis library and assigning a length value for each quantum state basis (operation 202). Each of the selected quantum state bases includes a set of (e.g., two) orthogonal quantum states and is identified by a unique QID. Note that the pre-installed quantum state basis library can be a shared secret between the client and the server. Similarly, the corresponding relationship between the QIDs and the actual quantum state bases can also be a shared secret between the client and server. This corresponding relationship can be time varying and synchronized between the client and the server. Next, the client process encrypts the dynamic message using a symmetric quantum key Key_{—AB} shared between the client and server (operation 204). The quantum bases, thus the QIDs, can be randomly selected by the client from the quantum state basis library, and the length corresponding to a particular QID can also be a random number. In an example, the client can select quantum bases with QIDs 2 and 4, and assign lengths 3 and 6, respectively, for the selected quantum bases. Accordingly, the encrypted dynamic message is {2, 3; 4, 6}_{Key}_{_}_{AB}. The client subsequently transmits the encrypted dynamic message along with the client's personal identification information, which can includes the client's user ID and identity certificate, to a server as a dynamic service request (operation 206). In some embodiments, this encrypted message can be sent via a classical communication channel. For example, this encrypted message can be transmitted using the standard https protocol. In addition to the symmetric quantum key Key_{—AB}, the client may also choose to use the server's public key to encrypt the dynamic message.

Next, in response to the service request, the client process receives dynamic information from the server (operation 208). In some embodiments, the dynamic information can be received via a quantum channel, and can include a dynamic quantum key r. More specifically, the server first generates a random binary bit string having a length equal to the sum of the length values specified in the dynamic message sent by the client. The server then generates a quantum bit string by encoding different portions of the random bit string using the quantum bases specified in the dynamic message sent by the client. For example, if the received dynamic message specifies {2, 3; 4, 6,}, the first three bits of quantum key r can be encoded using QID_2, and the subsequent six bits can be encoded using QID_4. The quantum bit string can then be transferred to the client via the quantum channel. As mentioned above, the received dynamic message includes cross-validation information for the client to verify the identity of the server, because only the server knows the QIDs and lengths specified by the client. In some embodiments, the dynamic quantum key r includes a bit string of length m. wherein m is a pre-agreed value between the client and the server. In some embodiments, the length of the dynamic quantum key r is no greater than the agreed length m. In some further embodiments, the length of the dynamic quantum key r is configured to be no less than a threshold length, considering possible ranges of light attenuation. In a particular embodiment, the length of the dynamic quantum key r equals m=l₁+l₂+ . . . +lₙ, wherein l₁, l₂, . . . , lₙ are the length values corresponding to the quantum bases specified by the client in operation 202.

For enhanced security, in addition to the quantum string, the client may also receive an encrypted message, which can include a different form of the dynamic quantum key r from the server. More specifically, the server can convert different portions of the binary bit string into decimal values, and send these decimal values in encrypted form to the client. For example, the server can convert the first three bits (string q1) of the quantum key r into a decimal number Q1 and the subsequent six bits (string q2) of the quantum key r into a different decimal number Q2, and send {Q1, Q2}_{Key}_{_}_{AB} to the client via a classical communication channel.

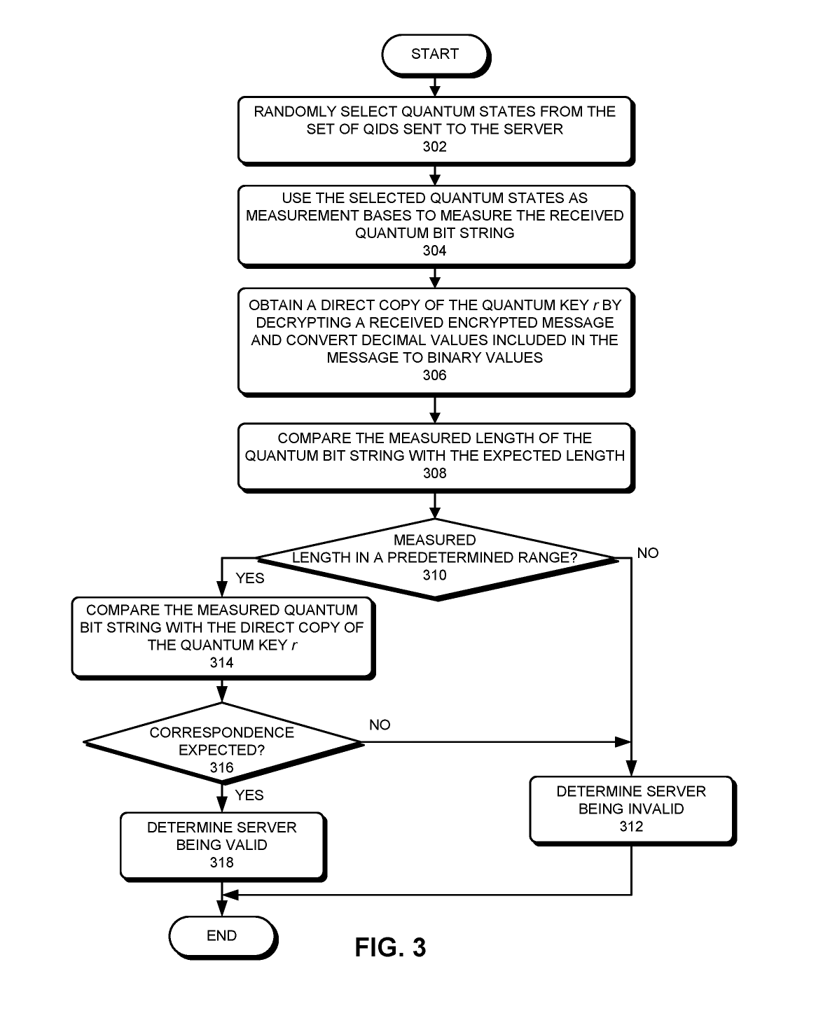

Next, the client processes the received dynamic information (operation 210) and determines whether the identity of the server can be verified based on the received dynamic information (operation 212). A more detailed embodiment of operations 210 and 212 is provided below in conjunction with FIG. 3.

If the identity of the server cannot be verified, the client process terminates. If the identity of the server is verified, the client subsequently generates a new message, which can include the measurement result of the received quantum bit string and particular quantum states used for the measurement (operation 214). For example, if the client uses quantum states 2.1 and 4.2 to measure the beginning three bits and the ending six bits of the received quantum bit string, this new message will include both the measurement result and the quantum state identifiers 2.1 and 4.2. By providing the exact quantum states used for the quantum measurement, the client allows the server to deduct the expected measurement result of the quantum bit string in order to cross-validate the client. In some embodiments, the new message can be encrypted with the symmetric quantum key Key_{—AB}. The client process then transmits the new message to the server for final service request approval (operation 216).

FIG. 2B presents a diagram illustrating a client device in accordance with one embodiment described herein. Client device 240 can include a quantum basis library 242, a server request generator 244, an encryption module 246, a service request transmitter 248, a receiving module 250, a quantum measurement module 252, a decryption module 254, a comparison module 256, a validation message generator 258, and a validation message transmitter 260.

During operation, service request generator 244 can generate a service request, which can include a number of QIDs corresponding to quantum bases stored in quantum basis library 242 and a number of length values. Encryption module 246 encrypts the service request, and service request transmitter 248 transmits the encrypted service request to a server. In response to the service request, receiving module 250 receives dynamic server validation information from the server. The dynamic server validation information can include a quantum bit string and an encrypted message, both corresponding to a server generated random bit string. Quantum measurement module 252 measures the received quantum bit string using quantum bases corresponding to the QIDs specified in the previously sent service request. More specifically, quantum measurement module 252 selects, from each quantum basis, a random quantum state for measurement purposes. Decryption module 254 decrypts the received encrypted message to obtain a direct copy of the server generated bit string. Comparison module 256 compares the quantum measurement result of the quantum bit string and the direct copy of the server generated bit string to determine the validity of the server. In some embodiments, comparison module 256 compares the measured length of the quantum bit string to an expected value to determine the validity of the server. If the server is determined to be valid, validation message generator 258 generates a message that can be used to validate the client. In some embodiments, the client validation message can include the quantum measurement result and the particular quantum states used to obtain the measurement result. The client validation message can be encrypted. Validation message transmitter 260 can send the encrypted client validation message to the server.

FIG. 3 presents a flowchart illustrating a process for verifying the identity of the server sending the dynamic information, in accordance with one embodiment described herein. The process can begin by randomly selecting quantum states from the set of quantum bases identified by the QIDs previously sent by the client to the server (operation 302). In some embodiments, randomly selecting a quantum state includes selecting one of the two orthogonal quantum states within a particular quantum state basis corresponding to the specified QID. For example, the client can select state |+> or state |−> from basis {|+>, |−>} and use the selected state as measurement basis.

Next, the client can use the selected set of quantum states as measurement bases to measure the corresponding portions of the received quantum bit string (operation 304). In some embodiments, the measurement result can provide both the length of the received quantum bit string and the bit values of each portion. If the client also receives an encrypted message that includes the decimal values of various portions of the quantum key r, the client can decrypt the encrypted message and covert the decimal values to binary to obtain a direct copy of the dynamic quantum key r (operation 306). For example, the process can decrypt the receive message {Q1, Q2}_{Key}_{_}_{AB} to obtain decimal numbers Q1 and Q2, and subsequently convert Q1 and Q2 back to binary strings q1 and q2. The concatenated binary string (q1, q2) is a direct copy of the quantum key r, which is randomly generated by the server.

The process then compares the measured length of the received quantum bit string with the expected value, which is the sum of the length values specified in the server request sent by the client (operation 308), and determines whether the measured length is within a predetermined range of the expected value. Because only the intended server knows the expected length, the length measurement can verify the identity of the server. For example, if the client previously sent the service request that specifies the QIDs and corresponding lengths as {2, 3; 4, 6}, the expected length of the received quantum bit string should be 3+6=9. In some embodiments, the measure length of the received quantum bit string should be less than (due to light attenuation) or equal to the expected value. Given known attenuation ratio, the measured length should also be greater than a predetermined threshold value. If the measured length is outside of the predetermined range of the expected value, the server is determined to be invalid (operation 312).

If the server passes the length test, the client can further compare the measurement result of the quantum bit string to the direct copy of the dynamic quantum key r (operation 314) and determines whether the correspondence between the measurement result and the direct copy of the quantum key r meets the expectation (operation 316). For the same reason stated above, only a valid server possesses the knowledge of the mapping between the QIDs and the quantum state bases. This means that only the valid server can generate a quantum bit string that can be correctly measured using the client-specified QIDs. For example, by decrypting the received encrypted message {Q1, Q2}_{Key}_{_}_{AB}, the client can determine that the first portions of the quantum key r includes a bit string q1. If the server is valid, the first corresponding portion of the received quantum bit string is encoded using a quantum basis specified by the client (e.g., QID_2). Hence, when the client uses a random quantum state of that quantum basis to measure the first portion of the received quantum bit string, the measurement result (i.e., the bit values) should be the same or inverse (depending on the quantum state used for the measurement) of q1. On the other hand, an invalid server may use a mismatched quantum basis to encode the quantum key r.

When the client uses a mismatched quantum basis to measure the received quantum bit string, the mismatching between the quantum basis used for sending the quantum bit string and the one used for measurement will result in the measured result to have a relatively large (e.g., around 50%) bit error rate.

If the correspondence between the measurement result and the direct copy of the quantum key r meets the expectation, the client can determine that the server is a valid server (operation 318); otherwise, the server is determined to be invalid (operation 312). Considering transmission loss, in some embodiments, the client can validate a server if the total error rate of the comparison is within a predetermined range. For example, the system can define an allowable error rate as 6%. If the comparison error rate obtained by comparing various portions of the measured quantum bit string with the direct copy of the quantum key r is 5%, the client can determine that the server is valid.

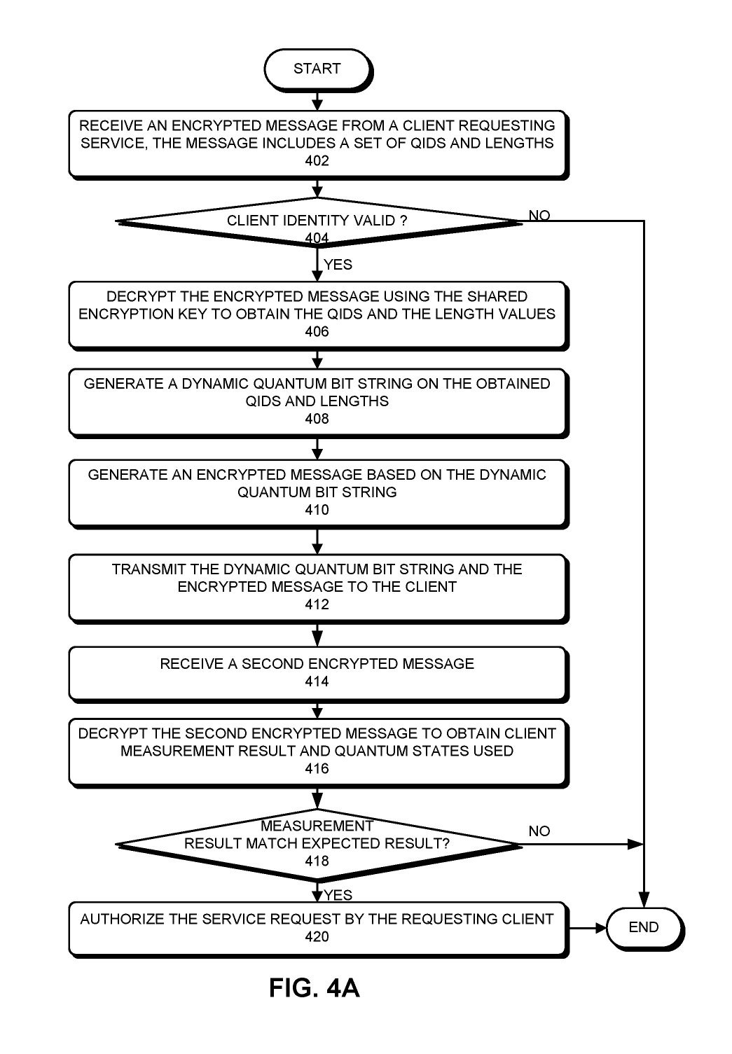

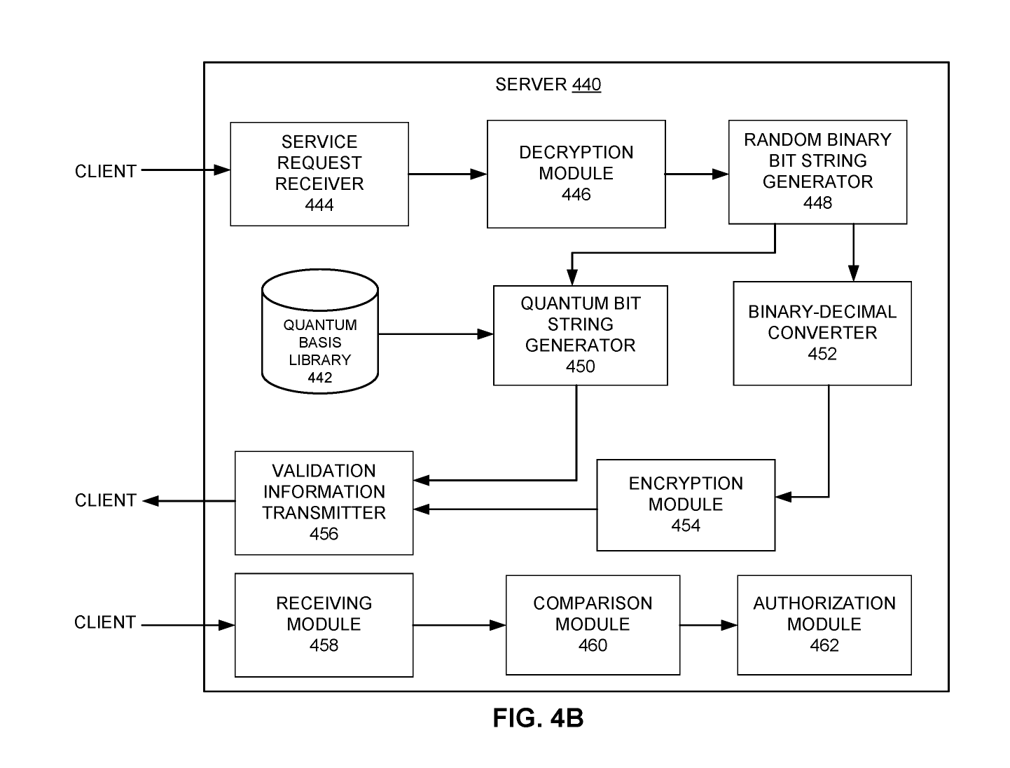

FIG. 4A presents a flowchart illustrating a server-side process of the disclosed dynamic-password authentication process in accordance with one embodiment described herein. The process begins when the server receives a service request from a client requesting the service from the server. The service request can include an encrypted message that set of a set of QIDs and length values, with each QID corresponding to a particular length value (operation 402). In some embodiments, the received service request can also include the client's personal identification information including one or both of a user_ID and an identity certificate.

Upon receiving the service request, including the encrypted message and the personal identification, the server determines whether the identity of the client is valid based on the received personal identification (operation 404). If the identification of the client is determined to be invalid, the process terminates. Otherwise, the process decrypts the encrypted message (e.g., by using a shared encryption key) to obtain the QIDs and the length values (operation 406). Because a valid client and the server have both pre-installed the same quantum state basis library, the server can identify the quantum state bases specified in the received message based on the obtained QIDs. In some embodiments, prior to decrypting the encrypted message, the process searches for the shared encryption key based on a received user_ID of the client sending the service request. In some embodiments, the shared encryption key is a quantum symmetric key.

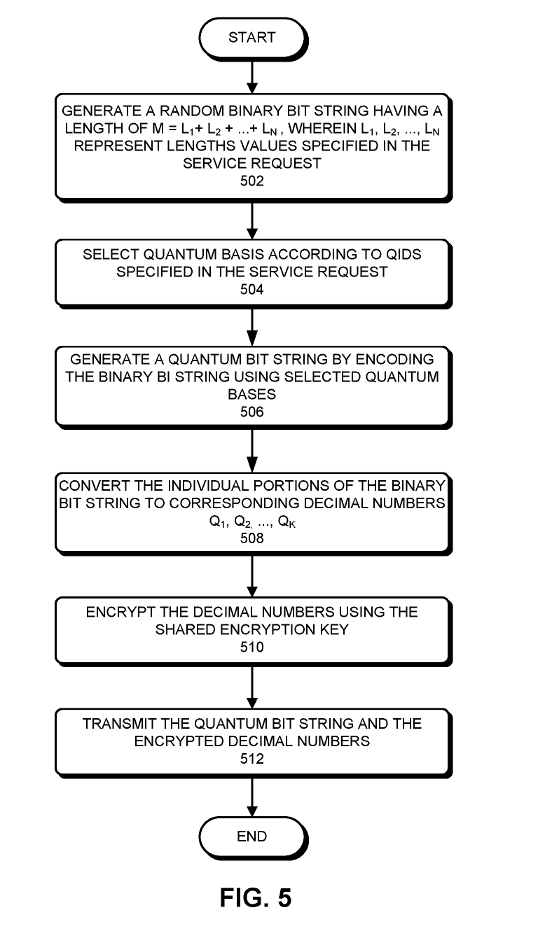

Subsequently, the server generates a dynamic quantum bit string based on the obtained QIDs and length values (operation 408). In some embodiments, the total length of the generated quantum bit string can be the sum of the length values specified in the service request, and the various portions of the quantum bit string can be encoded using quantum bases corresponding to the QIDs specified in the service request. In addition to the quantum bit string, the server can also generate an encrypted message based on the quantum bit string (operation 410). A more detailed embodiment of operations 408 and 410 is provided below in conjunction with FIG. 5. The server subsequently transmits the dynamic quantum bit string via a quantum channel and the encrypted message via a classical channel to the client (operation 412). In some embodiments, the encrypted message can be encrypted with the symmetric encryption shared between the requesting client and the server.

Next, the server receives a second encrypted message from the client, wherein the second encrypted message includes measurement result obtained by the client for the quantum bit string and particular quantum states used by the client for the measurement (operation 414). The server can decrypt the received second encrypted message to obtain the client's measurement result and the particular quantum states used for the measurement (operation 416). For example, if the client uses quantum states 2.1 and 4.2 to measure the beginning three bits and the ending six bits of the received quantum bit string, the second encrypted message will include both the measurement result and the quantum states identifiers 2.1 and 4.2. The server can deduct the expected measurement result for the quantum bit string based on the quantum states used for the measurement (operation 416), and determines if the received measurement result match the expected result (operation 418). As mentioned above, only a valid client knows the QIDs used by the server for sending the quantum bit string. Therefore, only a valid client can provide a measurement result that matches the expected result. Hence, if the received measurement results match the expected result, the server authorizes the service request by the requesting client (operation 420). Otherwise, the authentication process terminates.

FIG. 4B presents a diagram illustrating a server device, in accordance with one embodiment described herein. Server device 440 can include a quantum basis library 442, a server request receiver 444, a decryption module 446, a random binary bit string generator 448, a quantum bit string generator 450, a binary-decimal converter 452, an encryption module 454, a validation message transmitter 456, a receiving module 458, a comparison module 460, and an authorization module 462.

During operation, service request receiver 444 receives a service request from a client and decryption module 446 decrypts the received service request. The service request can specify a number of QIDs and length values. Random binary bit string generator 448 generates a random binary bit string based on the received service request. More specifically, the length of the generated bit string is the sum of the length values. Quantum bit string generator 450 can access quantum basis library to obtain a set of quantum bases based on the QIDs and generate a quantum bit string by encoding the random binary bit string using the obtained quantum bases. Binary-decimal convertor 452 converts various portions (based on the length values) of the binary bit string into decimal numbers, and encryption module 454 encrypted the decimal numbers.

Validation information transmitter 456 transmits the server validation information, which includes the quantum bit string and the encrypted decimal numbers, to the client. The server validation information can be used by the client to validate the identity of the server. If the client validates the server, receiving module 458 will receive an encrypted message from the client. The encrypted message can include the client's measurement result of the quantum bit string and identification of the quantum states used by the client for the measurement. Comparison module 460 can compare the client's measurement result to the expected result, and if the client's measurement result matches the expected result, authorization module 462 authorizes the received service request; otherwise, authorization module 462 denies the received server request.

FIG. 5 presents a flowchart illustrating a process for generating dynamic information for server validation in accordance with one embodiment described herein. The process can begin by the server generating a random binary string (e.g., a quantum key r) having a length of m=l₁+l₂+ . . . +lₙ, wherein l₁, l₂, . . . , lₙ represent the length values specified in a service request sent by a client (operation 502). Each length value corresponds to a QID. For example, l₁, l₂, . . . , lₙ correspond to QID_1, QID_2, . . . , QID_n, respectively. Next, the process selects, from a locally installed quantum basis library, a set of quantum bases according to the QIDs specified in the service request (operation 504). The process can then generate a quantum bit string by encoding the various portions of the binary bit string using the selected quantum bases (operation 506). For example, the first l₁ bits of the binary bit string can be encoded using a quantum basis QID_1, the subsequent l₂ bits of the binary bit string can be encoded using a quantum basis QID_2, and so on, and the last lₙ bits of the binary bit string can be encoded using a quantum basis specified by QID_n. Note that, when encoding, the server can randomly select, from each quantum basis, a quantum state to represent the “1” bits.

For enhanced security, the process can also converts the individual portions of the binary string to corresponding decimal numbers Q₁, Q₂, . . . , Qₙ (i.e., the first l₁ bits of the binary string can be converted to decimal number Q₁, the subsequent l₂ bits of the binary string can be converted to decimal number Q₂, and so on, and the last lₙ bits can be converted to decimal number Qₙ) (operation 508). The process subsequently generates an encrypted message by encrypting the decimal numbers using the shared encryption key (operation 510). The process can then transmit both the quantum bit string and the encrypted message from the server to the client (operation 512).

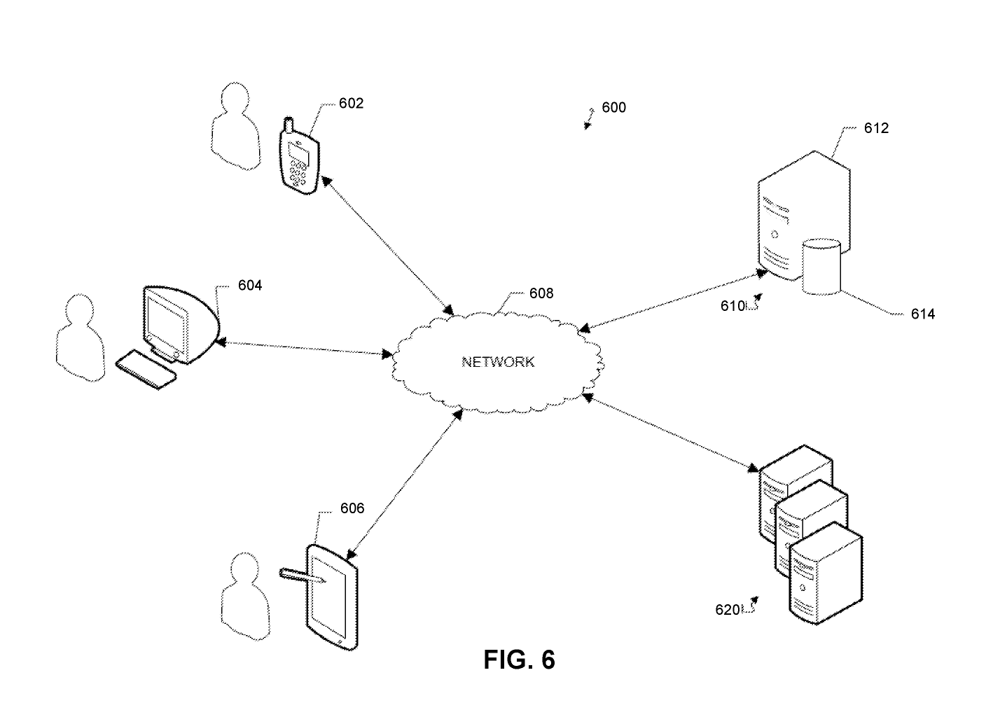

FIG. 6 illustrates an example client-server network environment which provides for implementing the disclosed dynamic-password authentication process in accordance with some embodiments described herein. A network environment 600 includes a number of electronic devices 602, 604 and 606 communicably connected to a server 610 by a network 608. One or more remote servers 620 are further coupled to the server 610 and/or the one or more electronic devices 602, 604 and 606.

In some example embodiments, electronic devices 602, 604 and 606 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In one example, the electronic devices 602, 604 and 606 store a user agent such as a browser or application. In the example of FIG. 6, electronic device 602 is depicted as a smartphone, electronic device 604 is depicted as a desktop computer, and electronic device 606 is depicted as a PDA.

Server 610 includes a processing device 612 and a data store 614. Processing device 612 executes computer instructions stored in data store 614, for example, to assist in scheduling a customer-initiated service or a service-provider-initiated service between a service provider and a customer at electronic devices 602, 604 and 606 during a service scheduling process.

In some example aspects, server 610 can be a single computing device such as a computer server. In other embodiments, server 610 can represent more than one computing device working together to perform the actions of a server computer (e.g., cloud computing). The server 610 may host the web server communicably coupled to the browser at the client device (e.g., electronic devices 602, 604 or 606) via network 608. In one example, the server 610 may host a client application for scheduling a customer-initiated service or a service-provider-initiated service between a service provider and a customer during a service scheduling process. Server 610 may further be in communication with one or more remote servers 620 either through the network 608 or through another network or communication means.

The one or more remote servers 620 may perform various functionalities and/or storage capabilities described herein with regard to the server 610 either alone or in combination with server 610. Each of the one or more remote servers 620 may host various services. For example, servers 620 may host services providing information regarding one or more suggested locations such as web pages or websites associated with the suggested location, services for determining location of one or more users, or establishments, search engines for identifying results for a user query, one or more user review or query services, or one or more other services providing information regarding one or more establishments, customers and/or review or feedback regarding the establishments.

Server 610 may further maintain or be in communication with social networking services hosted on one or more remote server 620. The one or more social networking services may provide various services and may enable users to create a profile and associate themselves with other users at a remote social networking service. The server 610 and/or the one or more remote servers 620 may further facilitate the generation and maintenance of a social graph including the user created associations. The social graphs may include, for example, a list of all users of the remote social networking service and their associations with other users of a remote social networking service.

Each of the one or more remote servers 620 can be a single computing device such as a computer server or can represent more than one computing device working together to perform the actions of a server computer (e.g., cloud computing). In one embodiment server 610 and one or more remote servers 620 may be implemented as a single server or across multiple servers. In one example, the server 610 and one or more remote servers 620 may communicate through the user agent at the client device (e.g., electronic devices 602, 604 or 606) via network 608.

Users may interact with the system hosted by server 610, and/or one or more services hosted by remote servers 620, through a client application installed at the electronic devices 602, 604, and 606. Alternatively, the user may interact with the system and the one or more social networking services through a web based browser application at the electronic devices 602, 604, 606.

Communication between client devices 602, 604, 606 and the system, and/or one or more services, may be facilitated through a network (e.g., network 608).

Communications between the client devices 602, 604, 606, server 610 and/or one or more remote servers 620 may be facilitated through various communication protocols. In some aspects, client devices 602, 604, 606, server 610 and/or one or more remote servers 620 may communicate wirelessly through a communication interface (not shown), which may include digital signal processing circuitry where necessary. The communication interface may provide for communications under various modes or protocols, including Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, including using a Bluetooth, WiFi, or other such transceiver.

The network 608 can include, for example, any one or more of a personal area network (PAN), a local area network (LAN), a campus area network (CAN), a metropolitan area network (MAN), a wide area network (WAN), a broadband network (BBN), the Internet, and the like. Further, the network 608 can include, but is not limited to, any one or more of the following network topologies, including a bus network, a star network, a ring network, a mesh network, a star-bus network, tree or hierarchical network, and the like.

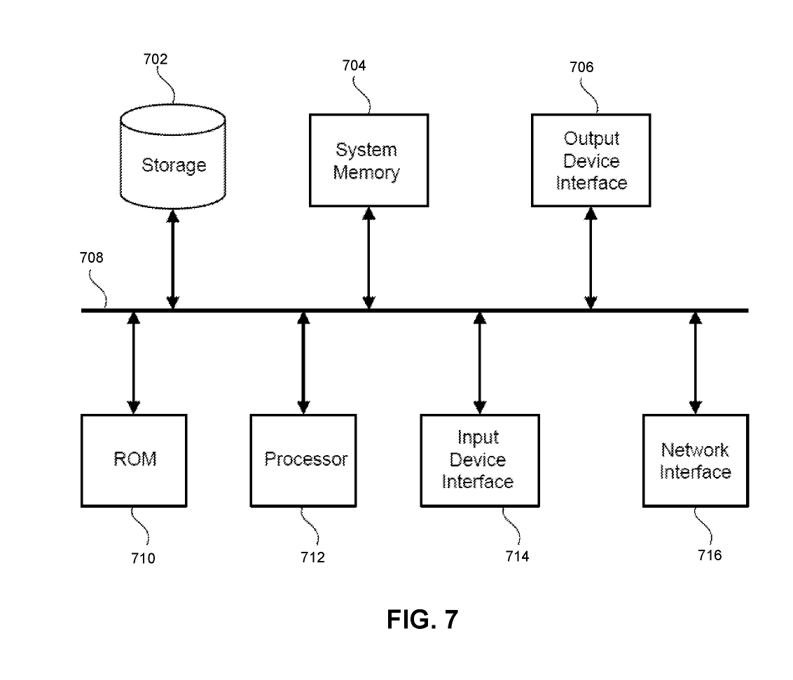

FIG. 7 conceptually illustrates an electronic system with which some implementations of the subject technology are implemented. Electronic system 700 can be a client, a server, a computer, a smartphone, a PDA, a laptop, or a tablet computer with one or more processors embedded therein or coupled thereto, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, such as cathode ray tubes (CRT) or liquid crystal displays (LCD). Some implementations include devices such as a touchscreen that functions as both input and output devices.

Finally, as shown in FIG. 7, bus 708 also couples electronic system 700 to a network (not shown) through a network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for performing dynamic-password authentication between a client and a server, the method comprising:
generating, by the client, a service request comprising a first dynamic message;
transmitting the first service request to the server;
receiving a second dynamic message from the server in response to the first dynamic message for cross-validating the server;
authenticating the second dynamic message to verify the validity of the server; and
if the validity of the server is verified,
generating a third dynamic message based on the second dynamic message and the first dynamic message; and
transmitting the third dynamic message to the server for a final approval of the service request.

2. The computer-implemented method of claim 1, wherein the first service request also includes identification information of the client.

3. The computer-implemented method of claim 1, wherein the first dynamic message is encrypted with a symmetric key shared by the client and the server.

4. The computer-implemented method of claim 1, wherein generating the first service request includes:
randomly selecting one or more quantum state bases from a pre-installed quantum state basis library, wherein each quantum state basis in the quantum state basis library includes a set of orthogonal quantum states, and is associated with a unique quantum state identifier (QID);
assigning a random length value to each selected quantum state basis; and
forming the first dynamic message using QIDs and assigned length values of the selected quantum state bases.

5. The computer-implemented method of claim 4, wherein authenticating the second dynamic message to verify the validity of the server includes:
processing the second dynamic message to obtain a set of dynamic values;
comparing the set of dynamic values with a set of expected values based on the QIDs and length values included in the first dynamic message; and
if the set of dynamic values match the set of expected values, determining that the server is valid;
otherwise, determining that the server is invalid.

6. The computer-implemented method of claim 5, wherein the second dynamic message includes a quantum bit string and an encrypted message, wherein the quantum bit string is generated by the server based on the QIDs and assigned length values in the first dynamic message, and wherein processing the second dynamic message includes:
selecting a set of measurement bases based on the QIDs; and
measuring the received quantum bit string using the selected measurement bases to obtain a set of measurement results.

7. The computer-implemented method of claim 6, wherein the set of expected values is indicated by the encrypted message, and wherein comparing the set of dynamic values with the set of expected values includes comparing the set of measurement results with the set of expected values to determine if the server is valid.

8. The computer-implemented method of claim 6, wherein the third dynamic message includes the set of measurement results and a set of quantum state identifiers that identify quantum states used for obtaining the set of measurement results.

9. A client device for performing dynamic-password authentication between the client device and a server, the client device comprising:
a service request generator configured to generate a service request that includes a first dynamic message;
a service request transmitter configured to transmit the first dynamic message to the server;
a receiver configured to receive a second dynamic message from the server in response to the first dynamic message for cross-validating the server;
an authentication module configured to analyze the second dynamic message to verify the validity of the server;
a message generator configured to generate a third dynamic message based on the first and second dynamic messages in response to the server being valid; and
a message transmitter configured to transmit the third dynamic message to the server for a final approval of the service request.

10. The client device of claim 9, further comprising a pre-installed quantum state basis library, wherein each quantum state basis in the quantum state basis library includes a set of orthogonal quantum states and is associated with a unique quantum state identifier (QID), and wherein the service request generator is configured to generate the service request by:
randomly selecting one or more quantum state bases from the pre-installed quantum state basis library;
assigning a random length value to each selected quantum state basis; and
forming the first dynamic message using QIDs and assigned length values of the selected quantum state bases.

11. The client device of claim 9, wherein the authentication module is configured to:
process the second dynamic message to obtain a set of dynamic values;
compare the set of dynamic values with a set of expected values; and
if the set of dynamic values match the set of expected values, determine that the server is valid;
otherwise, determine that the server is invalid.

12. The client device of claim 11, wherein the second dynamic message includes a quantum bit string and an encrypted message, wherein the quantum bit string is generated by the server based on the QIDs and assigned length values in the first dynamic message, and wherein while processing the second dynamic message, the authentication module is configured to:
select a set of measurement bases based on the QIDs; and
measure the received quantum bit string using the selected measurement bases to obtain a set of measurement results.

13. The client device of claim 12, wherein the set of expected values is indicated by the encrypted message, and wherein while comparing the set of dynamic values with the set of expected values, the authentication module compares the set of measurement results with the set of expected values to determine if the server is valid.

14. The client device of claim 12, wherein the third dynamic message includes the set of measurement results and a set of quantum state identifiers that identify quantum states used for obtaining the set of measurement results.

15. A computer-implemented method for performing dynamic-password authentication between a client and a server, the method comprising:
receiving, by the server, a service request comprising a first dynamic message and identity information from the client;
verifying the validity of the client based on the identity information; and
if the validity of the client is verified,
processing the first dynamic message to obtain a set of dynamic information;
generating a second dynamic message based on the set of dynamic information; and
transmitting the second dynamic message to the client to allow the client to cross-validate the server.

16. The computer-implemented method of claim 15, wherein the first dynamic message includes a set of quantum state basis identifiers (QIDs) and a set of length values, with each length value corresponding to a QID, wherein each QID corresponds to a quantum state basis in a quantum state basis library pre-installed on both the client and the server, and wherein each quantum state basis includes a set of orthogonal quantum states.

17. The computer-implemented method of claim 16, wherein obtaining the set of dynamic information includes obtaining the set of QIDs and length values.

18. The computer-implemented method of claim 17, wherein generating the second dynamic message based on the set of dynamic information includes:
generating a random binary bit string, wherein a length of the random binary bit string is the sum of the length values;
generating a quantum bit string from the random binary bit string based on the obtained QIDs and length values; and
generating a set of decimal numbers from the random binary bit string based on the length values.

19. The computer-implemented method of claim 18, further comprising encrypting the set of decimal numbers using a symmetric key shared by the client and the server.

20. The computer-implemented method of claim 15, further comprising:
receiving a third dynamic message in response to the second dynamic message from the client;
analyzing the third dynamic message to further determine the validity of the client; and
if so, authorizing the service request;
otherwise, denying the service request.

21. The computer-implemented method of claim 20, wherein the third dynamic message includes a measurement result of a quantum bit string included in the second dynamic message, wherein the measurement result is obtained by the client based on information included in the first dynamic message.

22. A server for performing dynamic-password authentication between a client and the server, the server comprising:
a service request receiver configured to receive a service request comprising a first dynamic message and identity information from the client;
a verifying module configured to verify the validity of the client based on the identity information;
a service request processing module configured to process the first dynamic message to obtain a set of dynamic information;
a message generator configured to generate a second dynamic message based on the set of dynamic information; and
a message transmitter configured to transmit the second dynamic message to the client to allow the client to cross-validate the server.

23. The server of claim 22, further comprising a pre-installed quantum state basis library, wherein the first dynamic message includes a set of quantum state basis identifiers (QIDs) and a set of length values, with each length value corresponding to a quantum state basis, wherein each QID corresponds to a quantum state basis in the pre-installed quantum state basis library, and wherein each quantum state basis includes a set of orthogonal quantum states.

24. The server of claim 23, wherein the set of dynamic information includes the set of QIDs and length values.

25. The server of claim 24, wherein while generating the second dynamic message, the message generator is configured to:
generate a random binary bit string, wherein a length of the random binary bit string is the sum of the length values;
generate a quantum bit string from the random binary bit string based on the obtained QIDs and length values; and
generate a set of decimal numbers from the random binary bit string based on the length values.

26. The server of claim 25, further comprising an encryption module configured to encrypt the set of decimal numbers using a symmetric key shared by the client and the server.

27. The server of claim 22, further comprising:
a message receiving module configured to receive a third dynamic message in response to the second dynamic message from the client;
an analyzing module configured to analyzing the third dynamic message to further determine the validity of the client; and
an authorization module configured to authorizing the service request in response to the analyzing module determining that the client is valid.

28. The server of claim 27, wherein the third dynamic message includes a measurement result of a quantum bit string included in the second dynamic message, wherein the measurement result is obtained by the client based on information included in the first dynamic message.
